(19) United States
(12) Patent Application Publication
(10) Pub. No.: US 2016/0107165 A1
(43) Pub. Date: Apr. 21, 2016

(54) ROTARY SHEAR FOR METAL SCRAP

(71) Applicant: FOR REC SRL, SANTA GIUSTINA IN COLLE (IT)

(72) Inventor: ZORAN STRAHINIC, SANTA GIUSTINA IN COLLE (IT)

(21) Appl. No.: 14/918,587

(22) Filed: Oct. 21, 2015

(30) Foreign Application Priority Data
Oct. 21, 2014 (IT) TV2014A000152

(51) Int. Cl. B02C 18/18; B02C 18/14; B02C 18/00

(52) U.S. Cl. CPC B02C 18/18; B02C 18/0084; B02C 18/142

(57) ABSTRACT

A rotary shear, e.g. for metal scrap, is described comprising a rotatable shaft (20) and a plurality of blades (60) attachable around the shaft to form a ring (30).

To improve the strength and the maintenance of the blades at least one blade is constrainable to an adjacent blade.

The invention relates in general to a shear machine for waste materials such as e.g. metal junk, residuals, or terminal or recyclable materials.

To tear apart metal scrapping powerful machines are used that grind and cut the scrapping by means of rotating shafts provided with blades or teeth, see e.g. U.S. Pat. No. 6,533,200.

The blades are secured to the shaft composing a ring, almost always in the shape of hexagon or octagon (but not necessarily) of which a blade constitutes one side (or a part of arc). The fixing occurs by screws, and to increase the resistance to the huge stresses imposed on the blades male-female joints are made between a blade and the shaft. Despite these structural reinforcements, a constant maintenance is required to replace the blades and to re-align them: the forces involved are so large that a blade, sooner or later, loses the original layout and must be restored. In the worst case a displaced blade could detach from the shaft, after which the detachment of all those belonging to the same ring immediately follows.

Since the maintenance is complicated and downtime is expensive, it is clear that this situation limits the productivity of the current rotary shears. It is desired to improve this state of the art, in particular by producing a rotary shear whose blades are more resistant to stresses.

It is therefore proposed a rotary shear, e.g. of industrial type and/or for metal scrap, comprising

a rotatable shaft;

a plurality of blades attachable around the shaft to form a ring,

wherein at least one blade is constrainable to an adjacent blade.

Unlike the prior art, which taught to bind the blades to the shaft only and not to each other, this solution greatly increases the resistance of the ring or pack of blades. The ring or pack of blades stiffens due to the constraints between blade and blade.

In general any type of constraint is exploitable, e.g. welding, mutual screwing or mutual connection of two blades via a (third) element fixed or fixable to both.

For blade here it is meant any means that can be mounted on the shaft for cutting the material: e.g. teeth, knives or dowels.

To maximize the speed of replacement and assembly, the rotary shear may comprise a member adapted to oppose the rotation of two adjacent blades about an axis, the axis passing through a blade and being orthogonal to and intersecting the axis of the shaft. This is a simple but effective system to rapidly connect two blades to the ring.

As a preferred embodiment, the element is mounted in contact with two blades or is mounted integral with a blade. In the first case a rigid bridge between two blades is created; in the second, one can exploit the interference between parts or an interlocking.

In particular, the or two blades may be configured so that a blade comprises a male part insertable into a corresponding cavity or female-part of another blade. The interlocking of male and female parts is very robust and easy to obtain through direct shaping of the blades.

Another variant is that the or two blades comprise a cavity or female part, the cavity or female parts of two blades being facing when the blades are mounted on the shaft, and a joining element may occupy the facing cavities to constrain the two blades to each other. Having all blades with parts or female cavities allows producing blades all equal to one another.

It is preferable that the male part does not hinder the assembly, therefore said element or the male part and/or the cavity or female part may be arranged on one side of the blade that it intended to contact the adjacent blade.

Note that the more blades are fastened to each other, the greater the overall resistance of the ring of blades. So it is advantageous to constrain to each other all or the majority of the blades of the ring, in particular by one or more of the constraint systems defined above.

Another aspect of the invention is an assembly method for mounting a plurality of blades which can be fixed around the rotating shaft of a rotary shear, e.g. for metal scrap, wherein the blades form a ring of blades around the shaft,

comprising the step of

constraining at least one blade to an adjacent blade.

As variants of the method there are comprised those said above for the machine, in particular:
the or two blades are mutually connected to each other, for example through a member fixed or attachable to both; and/or
the member is mounted in contact with two blades or mounted integral with a blade; and/or
the or two blades are fitted together, for example, by means of a male part insertable into a corresponding cavity or female part of another blade; and/or
the or two blades are connected to each other by equipping them with a cavity or female part, and

two adjacent blades are mounted on the shaft with the cavities or female parts facing each other, and

a joining element is mounted for occupying the facing cavities in order to bind the two blades to each other; and/or
the side of a blade is equipped with a male part and a female part, then mounting two blades in contact with each other and with the male part and female part interlocked.

Another aspect of the invention is an abovementioned blade or kit (plurality) of blades mountable around the rotatable shaft of an abovementioned rotary shear. One blade or more blades are configured to be constrainble to an adjacent blade.

In particular, a blade
is adapted to be connected with another blade via a (third) element fixed or fixable to both blades;
said element may be adapted to oppose the rotation of two adjacent blades about an axis which passes through a blade and is orthogonal to and intersecting the axis of the shaft;
said element may be mounted in contact with two blades or mounted integral with a blade;
may comprise a male part insertable into a corresponding cavity or female part of another blade;
may comprise a cavity or female part, the cavities or female parts of two blades being facing when the blades are mounted on the shaft, and a joining element may occupy the facing cavities to constrain the two blades together;
in said element, either the male part and/or the cavity or female part may be present on one side of the blade, in particular destined to contact the adjacent blade.

The following description relates to a preferred embodiment of rotary shear and highlights its further advantages, with reference to the accompanying drawings in which:

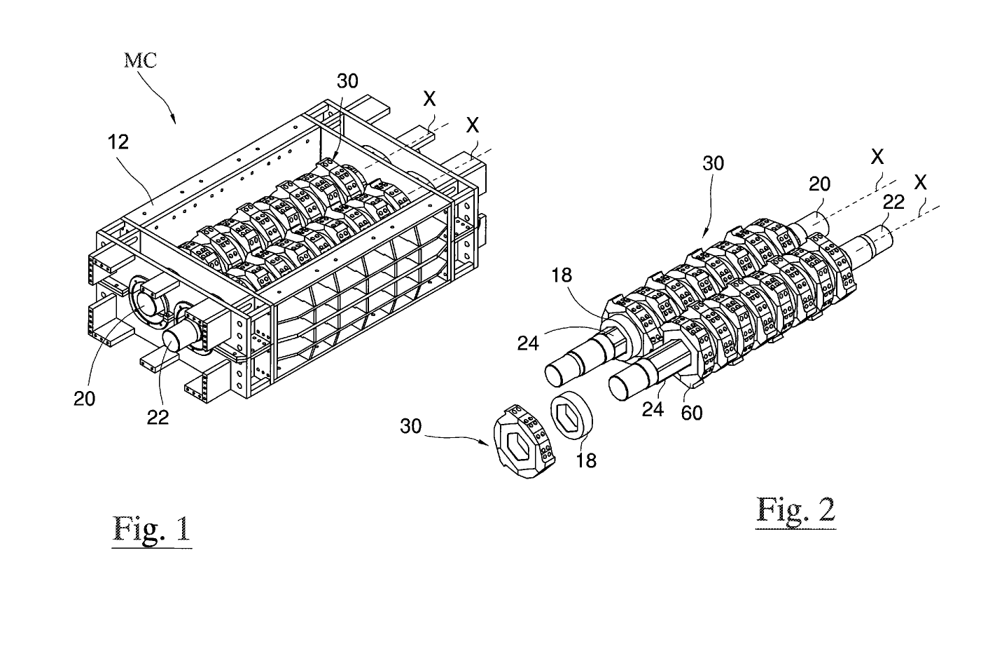

FIG. 1 shows a three dimensional view of a shears unit;

FIG. 2 shows a three dimensional view of components internal to the group of FIG. 1;

FIG. 3 shows an assembly of blades;

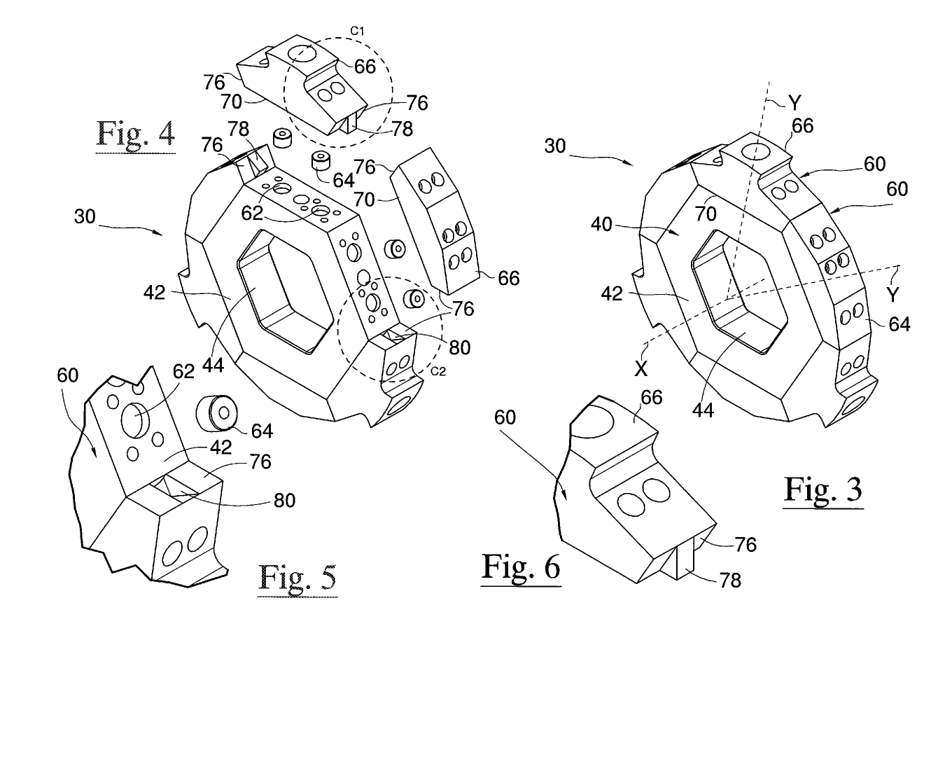

FIG. 4 shows an exploded view of the assembly in FIG. 3;

FIG. 5 shows an enlargement of the circle C1 in FIG. 3;

FIG. 6 shows an enlargement of the circle C2 in FIG. 3.

In the figures same numerals indicate same or similar parts, and the rotary shear is described as being in use. In order not to crowd the figures not all of the equal elements are marked.

FIG. 1 shows a unit MC of shear machine, part of a not-shown machine, formed by an external, e.g. rectangular, frame 12 with a pass-through cavity in the center in which are rotatably and transversely mounted two shafts 20, 22 (see the detail in FIG. 2). The shape or structure of the frame may be any of known type.

The two shafts 20, 22 have a central portion 24 with a polygonal, e.g. hexagonal (but not necessarily), section on which by sliding a cutter assembly 30 can be mounted. Such assembly 30 comprises a ring 40 and blades 60. The ring 40 is a single piece and comprises a (e.g. hexagonal) perimeter 42 and a central cavity 44 complementary to the section of the portion 24.

On each side of the ring 40 there are mounted blades 60 (FIGS. 3 and 4), one for each side, so as to cover the perimeter 42 by covering it with a ring composed of blades.

The ring 40 is optional, but it is convenient for mounting the blades 60 because it avoids applying them directly to the two shafts 20, 22.

The two shafts 20, 22 while rotating parallel around an axis X carry the material to be processed between the blades 60, that cut it.

Optional is also a spacer 18 useful for rigidly spacing the rings of blades 60 along the axis X and make them rotate, in known manner, in interdigitated configuration.

The cutting structure 66 of the blades 60, the one relative to the side that is in contact with the material, may be of any type.

The blades 60 may be fixed to the ring 40 via e.g. dowels 64 inserted at one side in a complementary cavity 62 provided on the perimeter 42 and at the other side in complementary cavities (not shown) provided in the base 70 of a blade 60.

To improve resistance to stresses, the blades 60 are all, or at least in pairs, constrained to each other so as to exert resistance to a rotation around an axis Y (FIG. 3) which extends radially and orthogonally from the axis X.

In a first variant (FIGS. 5 and 6), a blade 60 comprises, on the side 76 in contact with the adjacent blade 60 when mounted on the perimeter 42, a tooth 78, which may be integral but not necessarily, destined to insert into a (preferably complementary) cavity 80 of the side 76 belonging to the adjacent blade. The interlocking between the tooth 78 and the cavity 80 enhances the resistance of a blade 60 against rotation about the Y axis and against the translation with respect to the same axis Y.

To maximize the resistance, each blade 60 has a tooth 78 on a side 76, and on the opposite side 76 a cavity 80. In this way each blade 60 of the ring of blades contributes to the strength that the ring of blades altogether opposes to stresses. A circular, closed chain of constraints or male/female joints can—indeed—thus form such that the ring of blades 60 behaves as a single piece, improving its immovability.

In a second variant (not shown), one or each blade 60 comprises, on opposite sides 76 of its, a cavity e.g. such as that indicated by 80. To make such two blades 60 integral with one another, one may insert a rigid element (as a dowel) in the facing cavities of two adjacent blades 60. As in the first variant, it is convenient to mutually block all the blades, so each blade has two cavities on opposite sides 76. The rigid element may be held in place e.g. with stickers and/or a fixing screw to the blade.

1. Rotary shear (MC), e.g. for metal scrap, comprising
a rotatable shaft (20);
a plurality of blades (60) attachable around the shaft to form a ring (30),
characterized in that at least one blade is constrainable to an adjacent blade.

2. Shear according to claim 1, comprising a member (78) fixed or which can be fixed to two blades to obtain the mutual connection of said two blades.

3. Shear according to claim 1, comprising a member (78) adapted to oppose the rotation of two adjacent blades about an axis, the axis passing through a blade and being orthogonal to and intersecting the axis of the shaft.

4. Shear according to claim 2, wherein the member is mounted in contact with two blades or is mounted integral with a blade.

5. Shear according to claim 1, wherein two blades comprise a male part (78) insertable into a corresponding female cavity (80) of another blade.

6. Shear according to any one of the preceding claims 1, wherein two blades comprise a cavity or female part (80), the cavities or female parts of two blades being facing when the blades are mounted on the shaft, a joining member occupying the facing cavities.

7. Shear according to claim 5, wherein said member or the male part and/or the female part or cavity are arranged on one side (76) of the blade destined to contact the adjacent blade.

8. Assembly method for mounting a plurality of blades (60) which can be fixed about the rotating shaft (20) of a rotary shear (MC), e.g. for scrap metal, wherein the blades form a ring (30) of blades around the shaft, comprising the step of constraining at least one blade to an adjacent blade.

9. Method according to claim 8, with the step of connecting two blades to each other by equipping the side (76) of a blade with a male part (78) and a female part (80), then mounting two blades in contact with each other and with the male/female parts fitted together.

10. Method according to claim 8, with the step of mutually connecting the or two blades to each other, for example through a member fixed or attachable to both.

11. Method according to claim 10, with the step of mounting the member in contact with two blades or mounting the member integral with a blade.

12. Method according to claim 8, with the step of fitting together the blades by means of a male part insertable into a corresponding cavity or female part of another blade.

13. Method according to claim 8, wherein the or two blades are connected to each other by equipping them with a cavity or female part, and
two adjacent blades are mounted on the shaft with the cavities or female parts facing each other, and
a joining element is mounted for occupying the facing cavities in order to bind the two blades to each other.

14. Blade (60) for a rotary shear (MC), e.g. for metal scrap, which comprises a rotatable shaft (20) and a plurality of blades attachable around the shaft to form a ring (30),
characterized by being configured to be constrainable to an adjacent blade (60).
